(19) United States
(12) Patent Application Publication
(10) Pub. No.: US 2008/0240448 A1
(43) Pub. Date: Oct. 2, 2008

(54) Simulation of Acoustic Obstruction and Occlusion

(75) Inventors: Harald Gustafsson, Lund (SE); Erlendur Karlsson, Uppsala (SE)

Correspondence Address: POTOMAC PATENT GROUP PLLC, P. O. BOX 270, FREDERICKSBURG, VA, 22404, US

(73) Assignee: Telefonaktiebolaget L M Ericsson (publ), Stockholm (SE)

(21) Appl. No.: 11/867,145

(22) Filed: Oct. 4, 2007

Related U.S. Application Data
(60) Provisional application No. 60/828,250, filed on Oct. 5, 2006.
(60) Provisional application No. 60/829,911, filed on Oct. 18, 2006.

(51) Int. Cl. H04R 5/00

(52) U.S. Cl. 381/17

(57) ABSTRACT

Realistic simulation of acoustic obstruction/occlusion effects in virtual-reality software applications is achieved by specifying whether a type of filter function is low-pass or high-pass and a cut-off frequency and stop-band attenuation of the filter function. The stop-band attenuation can be specified merely qualitatively, for example as “weak”, “nominal”, or “strong”. As a complement or alternative, obstruction/occlusion can be specified in terms of obstruction objects, such as blocking objects, enclosure objects, surface objects, and medium objects. An obstruction object is specified in terms of one or more environmental parameters and corresponds to naturally occurring acoustically obstructive/occlusive objects, such as curtains, walls, forests, fields, etc. The two specification types—filter specification parameters and environmental parameters—may co-exist in the same implementation or one or the other of the interfaces can be used in a particular implementation.

This application claims the benefit of the filing dates of U.S. Provisional Patent Applications No. 60/828,250 filed on Oct. 5, 2006, and No. 60/829,911 filed on Oct. 18, 2007, both of which are incorporated here by reference.

### BACKGROUND

This invention relates to electronic creation of virtual three-dimensional (3D) audio scenes and more particularly to simulation of acoustic obstructions and occlusions in such scenes.

When an object in a room produces sound, a sound wave expands outward from the source and impinges on walls, desks, chairs, and other objects that absorb and reflect different amounts of the sound energy. FIG. 1A depicts an example of such an arrangement, and shows a sound source 100, three reflecting/absorbing objects 102, 104, 106, and a listener 108. It will be understood that the sound source 100 may be a natural sound generator, such as a person, animal, ocean, etc., or an artificial sound generator, such as a loud speaker, ear phone, etc., and the objects 102, 104, 106 may be objects in indoor or outdoor acoustic environments, such as the walls, floor, or ceiling of a room, the furniture or other objects in a room, objects in a landscape, etc.

Sound energy that travels a linear path directly from the source 100 to the listener 108 without reflection reaches the listener earliest and is called the direct sound (indicated in FIG. 1A by the solid line). The direct sound is the primary cue used by the listener to determine the direction to the sound source 100.

A short period of time after the direct sound, sound waves that have been reflected once or a few times from nearby objects 102, 104, 106 (indicated in FIG. 1A by dashed lines) reach the listener 108. Reflected sound energy reaching the listener is generally called reverberation. The early-arriving reflections are highly dependent on the positions of the sound source and the listener and are called the early reverberation, or early reflections. After the early reflections, the listener is reached by a dense collection of reflections called the late reverberation. The intensity of the late reverberation is relatively independent of the locations of the listener and objects and varies little with position in a room.

In creating a realistic 3D audio scene, or in other words simulating a 3D audio environment, it is not enough to concentrate on the direct sound. Simulating only the direct sound mainly gives a listener a sense of the angle to the respective sound source but not the distance to it.

A virtual-reality (VR) software application is a program that simulates a 3D world in which virtual persons, creatures, and objects interact with one another. FIG. 1A is a top view of such a 3D world. The VR application keeps track of everything in the virtual 3D world as well as their relative movements and renders both visual images that a specified observer in the virtual world would see and the spatial sound images that the observer would hear. Many electronic games are such VR applications, and VR applications are executed by many processing devices, such as Microsoft's Xbox, Sony's PlayStation, and Nintendo's Wii gaming consoles, and other computers.

A VR application can be structured as indicated by the block diagram in FIG. 2. An application programming interface (API) 202 is a software interface to the VR application that implements methods of specifying sizes and geometries of the virtual world and persons, creatures, observers, objects, etc. and their movements in the virtual 3D environment. The API 202 also implements methods of specifying sound sources that are coupled to specified persons, creatures, objects, events, etc. The API methods are handled by a Virtual World Manager 204, which is generally a procedural algorithm that can be implemented in either hardware, software, or both and that manages the virtual world and keeps track of the persons, creatures, observers, objects, etc. inhabiting the world and their movements in the world. For each observer, there is a Visual Renderer 206, which is generally a procedural algorithm that can be implemented in either hardware, software, or both and that takes care of rendering the visual image 208 seen by the observer, and a Sound Renderer 210, which is generally a procedural algorithm that can be implemented in either hardware, software, or both and that takes care of rendering the spatial sound image 212 heard by the observer.

The arrangement of the Sound Renderer 210 shown in FIG. 2 is consistent with the API for 3D audio world management described in Java Specification Request (JSR) 234, which is a specification that defines advanced multimedia functionality for a Java programming environment. Other APIs are possible. Examples of 3D sound engines suitable for mobile processors, such as mobile phones, are the mQ3D™ Positional 3D Audio Engine available from QSound Labs, Inc., Calgary, Alberta, Canada and the Sonaptic Sound Engine™ available from Wolfson Microelectronics PLC, Edinburgh, United Kingdom.

One of the difficulties in achieving a realistic VR experience is simulating the effect of acoustic obstruction or occlusion caused by an object or objects that block the direct acoustic path between a sound source and the observer. As this application focusses on the sound rendering process, the observer is referred to from now on as the listener. FIG. 1B, which is substantially similar to FIG. 1A, shows an environment in which a reflecting/absorbing object 102′ obstructs, i.e., blocks, the direct sound path from the source 100 to the listener 108. As depicted in FIG. 1B, sound reflected by the object 102′ bounces off object 106 before reaching the listener 108. If the object 102′ were located or made of a material such that it only partially blocked direct sound from the listener 108, the object 102′ would be an occlusion. In VR applications, obstructions and occlusions affect the Sound Renderer 210 and its interface to the Virtual World Manager 204.

When there is an obstruction or occlusion blocking the acoustic path from a sound source to a listener, the physical sound signal reaching a real-world listener is typically modeled as a low-pass-filtered version of the sound signal emitted by the source. Such low-pass filtering is described in the literature, which includes H. Medwin, “Shadowing by Finite Noise Barriers”, J. Acoustic Soc. Am., Vol. 69, No. 4 (April 1981); A L'Espérance, “The Insertion Loss of Finite Length Barriers on the Ground”, J. Acoustic Soc. Am., Vol. 86, No. 1 (July 1989); and Y. W. Lam and S. C. Roberts, “A Simple Method for Accurate Prediction of Finite Barrier Insertion Loss”, J. Acoustic Soc. Am., Vol. 93, No. 3 (March 1993).

The effects of acoustic obstructions in VR environments have been simulated by VR applications with low-pass-filtering operations at least since 1997, as illustrated by N. Tsingos and J. D. Gascuel, “Soundtracks for Computer Animation: Sound Rendering in Dynamic Environments with Occlusions”, Proc. Graphics Interface 97 Conf., Kelowna, British Columbia, Canada (May 21-23, 1997); U.S. Pat. No. 6,917,686 to Jot et al. for “Environmental Reverberation Processor”; and “Interactive 3D Audio Rendering Guidelines Level 2.0”, Prepared by the 3D Working Group of the Interactive Audio Special Interest Group, MIDI Manufacturers Association, (Sep. 20, 1999).

Different VR applications have implemented the low-pass-filtering operation in different ways. For example, the N. Tsingos et al. paper cited above describes a 256-tap, finite-impulse-response (FIR) low-pass filter where the attenuation at a number of frequencies was evaluated as the fraction of the Fresnel zone volume for the particular frequency that was blocked by the occlusion object. This method has an advantage of automatically updating the low-pass-filter parameters from the VR scene description, which thus relieves the VR-application developer from having to do that, but the computations require considerable computational resources. Tapped delay lines and their equivalents, such as FIR filters, are commonly used today in rendering or simulating acoustic environments.

The Jot et al. patent and Rendering Guidelines cited above specify the low-pass filtering in terms of an attenuation (A) at one predefined, but adjustable, reference frequency (RF) and a low-frequency ratio parameter (LFR), where the attenuation at 0 Hz is the product of A and LRF. This approach leaves it up to the VR-application developer to update the filter parameters and specifies the low-pass filter by defining the attenuation of the filter at two frequencies, 0 Hz and RF Hz. An advantage of this method is there are few filter parameters to update as the VR scene changes, but a significant disadvantage is that the method does not give the VR-application developer much control over the low-pass filter as it defines the filter at only two frequencies. This is a very serious drawback as it severely limits the “realness” with which obstruction/occlusion effects can be implemented.

### SUMMARY

In accordance with aspects of this invention, there is provided a method of generating an electronic signal that simulates obstruction or occlusion of sound by at least one simulated obstructive/occlusive object. The method includes the step of transforming a set of electronic filter characteristics into a set of filter parameters for a filter for altering a sound signal based on the filter characteristics. The set of electronic filter characteristics represents the obstructive/occlusive object and includes at least a filter type, a cut-off frequency, and a stop-band attenuation.

In accordance with further aspects of this invention, there is provided a method of simulating obstruction or occlusion of sound by at least one simulated obstructive/occlusive object. The method includes the steps of transforming at least one environmental parameter for at least one of a plurality of obstruction objects that corresponds to the at least one simulated obstructive/occlusive object into a set of electronic filter characteristics; and transforming the set of electronic filter characteristics into a set of filter parameters for a filter for altering an input sound signal based on the identified electronic filter characteristics.

In accordance with further aspects of this invention, there is provided an apparatus for simulating obstruction or occlusion of sound by at least one simulated obstructive/occlusive object. The apparatus includes a programmable processor configured to transform a set of electronic filter characteristics into a set of filter parameters for a filter for altering a sound signal based on the electronic filter characteristics. The set of electronic filter characteristics represents the obstructive/occlusive object and includes at least a filter type, a cut-off frequency, and a stop-band attenuation.

In accordance with further aspects of this invention, there is provided an apparatus for simulating obstruction or occlusion of sound by at least one simulated obstructive/occlusive object. The apparatus includes a programmable processor configured to transform at least one environmental parameter for at least one of a plurality of obstruction objects that corresponds to the at least one simulated obstructive/occlusive object into a set of electronic filter characteristics, and to transform the set of electronic filter characteristics into a set of filter parameters for a filter for altering an input sound signal based on the identified electronic filter characteristics.

In accordance with aspects of this invention, there is provided a computer readable medium having stored thereon instructions that, when executed by a processor, carry out a method of generating an electronic signal that simulates obstruction or occlusion of sound by at least one simulated obstructive/occlusive object. The method includes the step of transforming a set of electronic filter characteristics into a set of filter parameters for a filter for altering a sound signal based on the filter characteristics. The set of electronic filter characteristics represents the obstructive/occlusive object and includes at least a filter type, a cut-off frequency, and a stop-band attenuation.

In accordance with further aspects of this invention, there is provided a computer readable medium having stored thereon instructions that, when executed by a processor, carry out a method of simulating obstruction or occlusion of sound by at least one simulated obstructive/occlusive object. The method includes the steps of transforming at least one environmental parameter for at least one of a plurality of obstruction objects that corresponds to the at least one simulated obstructive/occlusive object into a set of electronic filter characteristics; and transforming the set of electronic filter characteristics into a set of filter parameters for a filter for altering an input sound signal based on the identified electronic filter characteristics.

### BRIEF DESCRIPTION OF THE DRAWINGS

The various objects, features, and advantages of this invention will be understood by reading this description in conjunction with the drawings, in which:

FIGS. 1A, 1B depict arrangements of a sound source, reflecting/absorbing objects, and a listener;

FIG. 2 is a block diagram of a virtual-reality software application;

FIG. 3 shows frequency response curves for three low-pass filters;

FIG. 4 shows frequency response curves for three low-pass filters;

FIGS. 5 and 6 are plots of filter attenuation with respect to frequency;

FIG. 7 is a flow chart of a method of simulating obstruction or occlusion of sound by an object;

FIG. 8 is a flow chart of a method of simulating obstruction or occlusion of sound by an object that corresponds to at least one obstruction object;

FIG. 9 is a block diagram of a sound renderer;

FIG. 10 is a block diagram of a sound source;

FIG. 11 is a flow chart of method of generating an electronic signal that corresponds to simulated obstruction or occlusion of sound by an object; and

FIG. 12 is a block diagram of an equipment for simulating obstruction or occlusion of sound by an object.

### DETAILED DESCRIPTION

Realistic simulation of acoustic obstruction/occlusion effects in VR applications would be expected to require specifying the shape of the corresponding (low-pass) filter function in more detail than has been done in prior approaches. The inventors have recognized that a suitable more-detailed specification does not require defining the filter function at a large number of frequency points, which would result in only added complexity without significant improvement in the perceived realness of the simulated effects. Instead, realistic obstruction/occlusion effects can be rendered without unnecessary complexity by specifying whether the type of filter function is low-pass or high-pass and the cut-off frequency and stop-band attenuation of the filter function. The stop-band attenuation can be specified merely qualitatively, for example as “weak”, “nominal”, or “strong”. It should be understood that although the following description is written mostly in terms of low-pass filtering, high-pass filtering can be more suitable for some VR environments and object types, e.g., porous materials, particular types of surfaces, etc.

As a complement or alternative to the above-described “low level” filter definition, obstruction/occlusion can be specified at a “high level”, i.e., in terms of a type variable, which itself is specified in terms of naturally occurring acoustic blocking objects, such as curtains, walls, forests, fields, etc., and one or more other variables that quantify the obstruction/occlusion effect in more detail.

The two specification types—“low level” filter specification parameters and “high level” obstruction/occlusion specification parameters—may co-exist in the same implementation or one or the other of the interfaces can be used in a particular implementation.

The inventors' approach has a number of significant advantages. For example, developers of VR applications may not be familiar with acoustics and the various filtering effects that occur in acoustic environments. Thus, it is advantageous to provide such developers with an API that enables them to specify obstruction/occlusion objects in a familiar and natural environmental terminology, which simplifies the developers' job.

### Filter Parameterization

As described above, filtering operations can be used to simulate the effect of acoustic obstruction and occlusion. In accordance with this invention, the filtering operation is specified at a “low level” in terms of a few filter specification parameters: the filter's 3-dB cut-off frequency f_{c}; a filter-type variable, which indicates whether the filtering to be performed is low-pass or high-pass; and the strength (e.g., weak, nominal, strong) of the stop-band attenuation of the filter.

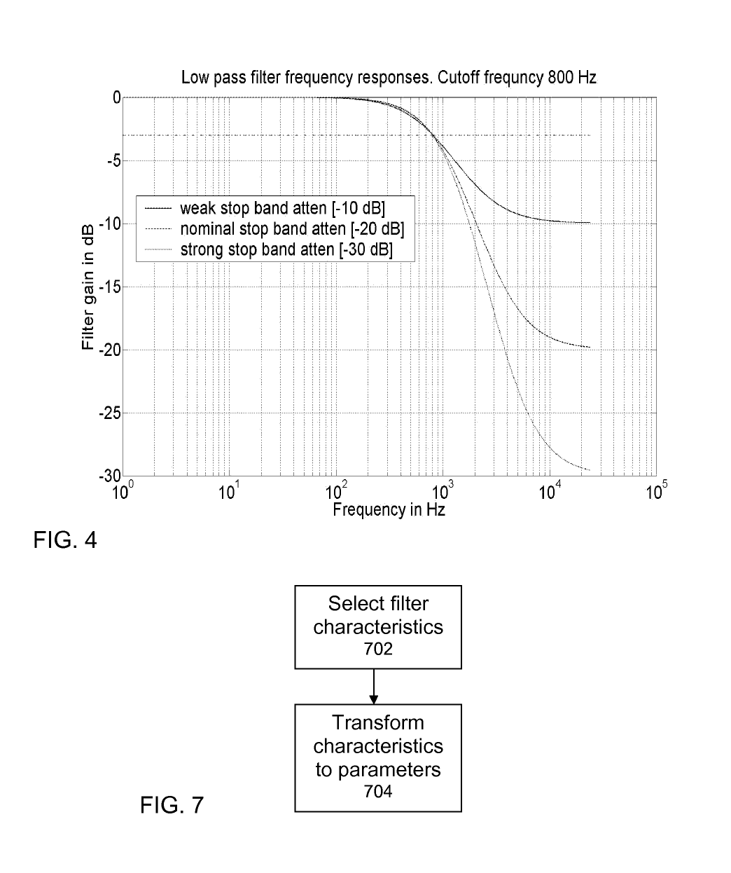

How these filter parameters shape a low-pass filter is shown in FIGS. 3 and 4, in which frequency ranges from 1 Hz to 100 KHz on the horizontal axis and gain ranges from −20 dB to 0 dB on the vertical axis. FIG. 3 shows the frequency response (gain-vs.-frequency) of a low-pass filter having a “nominal” stop-band attenuation and cut-off frequencies of f_{c}=200 Hz, 800 Hz, and 3200 Hz (3.2 KHz). FIG. 4 shows the frequency response of a low-pass filter having a cut-off frequency f_{c}=800 Hz and stop-band attenuations of weak, nominal, and strong. In FIGS. 3 and 4, a horizontal dashed line at 3 dB is shown for conveniently identifying the cut-off frequency. It may be noted in FIG. 4 that a “weak” stop-band attenuation is −10 dB, a “nominal” stop-band attenuation is −20 dB, and a “strong” stop-band attenuation is −30 dB, but it should be understood that other values can be used.

Mapping such filter specification parameters to a set of parameters that can be used to implement a filter in a VR application can be done in several ways.

One way is to map the filter specification parameters into a set of filter parameters that defines a discrete-time (or digital), infinite-impulse-response (IIR) filter, and then to implement the discrete-time filter, e.g., in terms of the set of filter parameters.

A discrete-time, low-pass, IIR filter is specified by the following z-transform:

$${H}_{k} ( z ) = {( \frac{( 1 - {e}^{- {f}_{p} / {f}_{s}} )}{\underbrace{( 1 - {e}^{- {f}_{z} / {f}_{s}} )}_{gain normalization}} \frac{1 - {e}^{- {f}_{z} / {f}_{s}} {z}^{- 1}}{1 - {e}^{- {f}_{p} / {f}_{s}} {z}^{- 1}} )}^{k}$$

in which Hₖ(z) is the filter function, k is the order of the filter, z is the complex argument variable of the z-transform, fₛ is the sampling frequency used by the audio device, f_{Z} is the frequency of a zero-value of the filter function, and fₚ is the frequency of a pole of the filter function.

FIGS. 3 and 4 show frequency responses of such a discrete-time, low-pass, IIR filter for the following specification parameter—to—filter parameter mappings:

TABLE 1

| Stop band | Filter | | |
|---|---|---|---|
| attenuation | order k | Pole fₚ | Zero f_{z} |
| weak | 1 | fₚ = 0.90\sqrt{k}f_{c} | f_{z} = 10^{0.5}fₚ |
| nominal | 2 | fₚ = 1.02\sqrt{k}f_{c} | f_{z} = 10^{0.5}fₚ |
| strong | 3 | fₚ = 1.05\sqrt{k}f_{c} | f_{z} = 10^{0.5}fₚ |

Another example of a mapping is to have the filter order k=2 for “strong” attenuation, rather than k=3 as shown in the table above, and to omit the zero f_{z}, which is to say that the filter has only poles. The frequency response of the resulting filter has a constant slope even at high frequencies. It should be understood that other ways of mapping the filter specification parameters to a set of implementable filter parameters can be used, and coefficients other than 0.5, 0.9, 1.02, 1.05, and √k can be used. Moreover, FIR filters can be used instead of or in addition to IIR filters as described in more detail below.

Suitable filter design techniques are described in the literature, including T. W. Parks and C. S. Burrus, Digital Filter Design, sections 7.1-7.6, Wiley-Interscience, New York, N.Y. (1987).

As another example, the filter specification characteristics cut-off frequency and filter type, including a slope of the transition from the pass-band to the stop-band, can be transformed by using known least-square-error filter design techniques into a FIR filter in the digital domain. Such a digital FIR filter can be described by a filter function h(n), and is advantageously designed to have a spline transition region function. The digital FIR filter is thus described by the following equation:

$$h ( n ) = \{ \begin{matrix}\frac{sin ( π ( {f}_{2} - {f}_{1} ) ( n - M ) )}{π ( {f}_{2} - {f}_{1} ) ( n - M )} \frac{sin ( π ( {f}_{2} + {f}_{1} ) ( n - M ) )}{π ( n - M )} , & 0 \leq n \leq N - 1 \\ 0 , & otherwise\end{matrix}$$

in which N is the number of filter coefficients, or the filter length, f₁ in normalized frequency is the start of the transition region between the pass-band and the stop-band, f₂ in normalized frequency is the end of the transition region between the pass-band and the stop-band, and the parameter M=(N−1)/2.

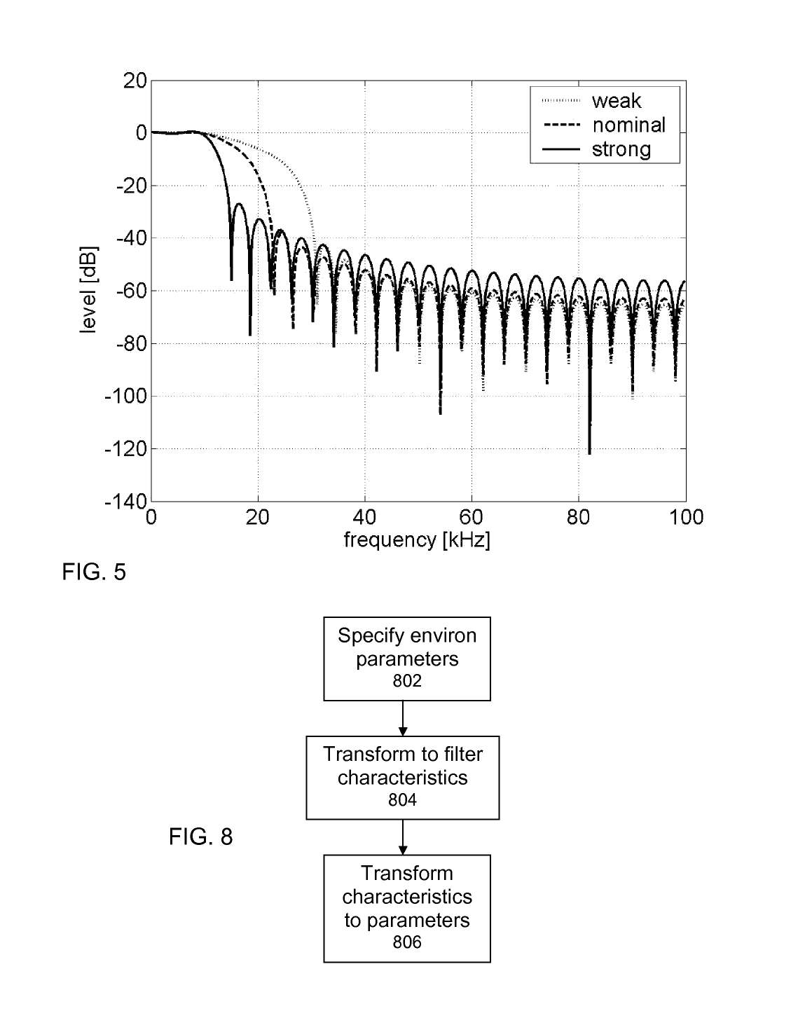

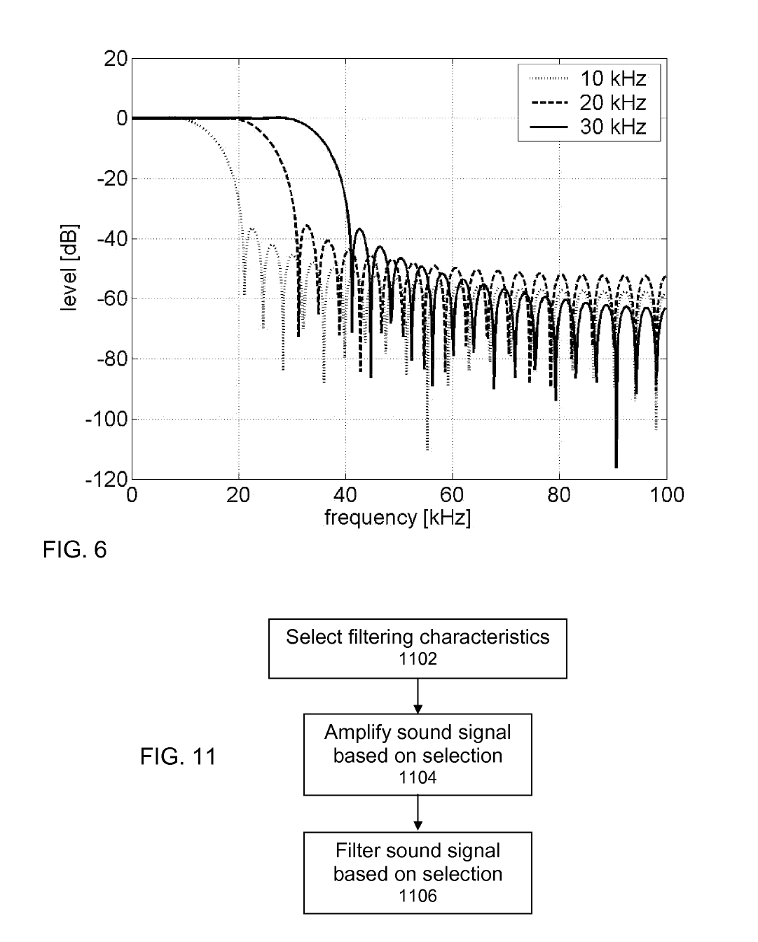

The start frequency f₁ can be used as the cut-off frequency, although it is not necessarily identical to the 3-dB cut-off frequency. The slope of the transition from the pass-band to the stop-band and the stop-band attenuation are dependent on the difference between the frequencies f₂ and f₁. Thus, the slope of this example filter is the link to the strength of the filter. Table 2 and FIG. 5 illustrate an example of filter-type strength variations, and Table 3 and FIG. 6 illustrate an example of cut-off frequency variations.

TABLE 2

| Filter type | Transition region width | Cut-off frequency |
|---|---|---|
| strength | (f₂ − f₁) in kHz | (f₁) in kHz |
| Weak | 20 | 10 |
| Nominal | 12 | 10 |
| Strong | 4 | 10 |

TABLE 3

| Transition region width | Cut-off frequency |
|---|---|
| (f₂ − f₁) in kHz | (f₁) in kHz |
| 10 | 10 |
| 10 | 20 |
| 10 | 30 |

FIGS. 5 and 6 are plots of filter attenuation in dB with respect to frequency in kHz, where the filter length N=51. In FIG. 5, three filter strengths are depicted by solid (strong), dashed (nominal), and dotted (weak) lines. In FIG. 6, three filter cut-off frequencies are depicted by solid (f_{c}=30 kHz), dashed (f_{c}=20 kHz), and dotted (f_{c}=10 kHz) lines.

FIG. 7 is a flow chart that illustrates a method of simulating obstruction or occlusion of sound by an object as described above. In step 702, filter specification characteristics are selected that represent the obstructive/occlusive object. As described above, the filter characteristics include a filter type, a cut-off frequency, and a stop-band attenuation. In step 704, the set of filter characteristics are transformed into a set of filter parameters suitable for implementing a filter for filtering an input sound signal. The set of electronic filter characteristics can be transformed by mapping the selected filter characteristics to a set of filter parameters that define a discrete-time IIR or FIR filter, and implementing the IIR or FIR filter as a digital filter.

It should be appreciated that the transformation (step 704) may involve transforming the set of filter specification characteristics into a set of parameters for a continuous-time (analog) filter, and then transforming the analog filter parameters into a set of digital filter parameters. For example, a continuous-time IIR filter is specified by the following equation:

$${H}_{k} ( f ) = {( \frac{1 + j ( f / {f}_{z} )}{1 + j ( f / {f}_{p} )} )}^{k}$$

in which Hₖ(f) is the filter function, k is the order of the filter, f is frequency, j is the square-root of −1, f_{z} is the frequency of a zero-value of the filter function, and fₚ is the frequency of a pole of the filter function. Equivalent equations for FIR filters are known in the art, as indicated by the above-cited book by Parks and Burrus, for example.

Filter specification characteristics can be mapped into such a continuous-time IIR filter according to Table 1. After this mapping is done, the analog filter parameters can be mapped into a set of filter parameters for a digital filter, which is more convenient for a VR application executed on a digital computer, by any of the known techniques for digitally approximating an analog filter. It will be appreciated that the above-described z-transform of a digital IIR filter can be obtained from the above-described analog filter equation through a matched z-transform mapping.

### Obstruction/Occlusion Parameterization

The inventors have also recognized that most physical obstruction/occlusion objects of interest can be categorized at a “high level” into a few types of objects, and each object of a given type can be conveniently specified in terms of environmental parameters that are particularly well suited for describing that type of object. A particularly advantageous categorization includes the following types of obstruction object: “blocking object”, “enclosure object”, “surface object”, “medium object”, and “custom object”. It will be appreciated that other categorizations and other type names are possible.

An obstruction object can be specified in terms of a data structure Obstruction_t that can be written in the C programming language, for example, as follows:

typedef struct Obstruction {

| | |
|---|---|
| ObstructionType_t | obstructionType; |
| void | obstructionSpec; |

} Obstruction_t;

The obstructionType variable in the obstruction_t data structure specifies the obstruction type as one of the types enumerated in a data structure ObstructionType_t, which can be written as follows:

typedef enum {

OBSTRUCTIONTYPE_BLOCKING_OBJ = 0,
OBSTRUCTIONTYPE_ENCLOSURE_OBJ,
OBSTRUCTIONTYPE_SURFACE_OBJ,
OBSTRUCTIONTYPE_MEDIUM_OBJ,
OBSTRUCTIONTYPE_CUSTOM_OBJ

} ObstructionType_t;

The obstructionSpec variable in the obstruction_t data structure is a void variable that is cast to a type-dependent specification data structure.

A common type of obstruction object is the “blocking object”, which represents physical objects, such as chairs, tables, panels, curtains, people, cars, and houses, just to name a few. The blocking effect of such an object is at its maximum when the sound path from the source to the listener goes directly through the middle of the object. The blocking effect decreases from that maximum as the intersection of the sound path and the object moves toward a side of the object and vanishes when the object no longer blocks the sound path from the source to the listener. The maximum blocking effect of the obstruction depends on several factors, such as the size of the object, its material density, and the distances from the object to the listener and to the sound source. In general, the values of the maxEffectLevel and other variables described below are adjusted such that the desired behavior of a VR acoustic environment is obtained.

The blocking effect is conveniently parameterized in terms of a maximum effect level parameter maxEffectLevel, which can take values in the range of 0 to 1, where 0 translates into no filtering at all and 1 translates into maximum attenuation for all frequencies. Similarly, the variation from no blocking effect to maximum blocking effect can be parameterized with a relative effect level parameter relativeEffectLevel, which can take values in the range of 0 to 1. Thus, the overall effect level of the obstruction, which can be represented by a variable effectLevel, is given by:

effectLevel=relativeEffectLevel·maxEffectLevel

The relativeEffectLevel and maxEffectLevel parameters can also be combined in other ways. For example, the maxEffectLevel parameter can affect the slope and the cut-off frequency of the stop-band in the underlying filter and the relativeEffectLevel parameter can affect the attenuation in the stop-band. Other combinations are also possible, e.g., the relativeEffectLevel parameter can affect the cut-off frequency.

Such a “blocking object” type of obstruction object can also be specified in terms of a set of predefined objects, such as a chair, couch, table, small panel, medium panel, large panel, curtain, person, car, and house, which can then automatically set the maxEffectLevel parameter for the object. A data structure that can be used to specify this type of an obstruction object is the specification data structure ObstructionSpec_BlockingObj_t, which can be written as follows:

typedef struct ObstructionSpec_BlockingObj {

| | | |
|---|---|---|
| permillie | maxEffectLevel; | // 0 to 1000 |
| permillie | relativeEffectLevel; | // 0 to 1000 |

ObstructionName_BlockingObj_t obstructionName;

} ObstructionSpec_BlockingObj_t;

The data type ObstructionName_BlockingObj_t is an enumeration of predefined obstruction object names. Such an enumeration can be written as follows, for example:

typedef enum {

OBSTRUCTIONNAME_CHAIR = 0,
OBSTRUCTIONNAME_COUCH,
OBSTRUCTIONNAME_TABLE,
OBSTRUCTIONNAME_PANEL_SMALL,
OBSTRUCTIONNAME_PANEL_MEDIUM,
OBSTRUCTIONNAME_PANEL_LARGE,
OBSTRUCTIONNAME_CURTAIN,
OBSTRUCTIONNAME_PERSON,
OBSTRUCTIONNAME_CAR,
OBSTRUCTIONNAME_TRUCK,
OBSTRUCTIONNAME_HOUSE,
OBSTRUCTIONNAME_BUILDING,
OBSTRUCTIONNAME_CUSTOM

} ObstructionName_BlockingObj_t;

In the case of a “custom” obstruction object, the maxEffectLevel variable is specified.

As an alternative, the ObstructionName variable can be excluded from the data structure ObstructionSpec_BlockingObj_t and the predefined object names can be mapped directly to values of the maxEffectLevel variable. Such mapping can be done in the C language with #define statements. For example, two such statements are as follows:

#define BLOCKINGNAME_CHAIR 23
#define BLOCKINGNAME_COUCH 97

It will be appreciated that equivalent mapping can be carried out in other programming languages.

Another common type of obstruction object is the “enclosure object”, which is used to model physical objects having interior spaces that can be opened and closed via some sort of openings. Such objects include the trunk of a car, a closet, a chest, a house with a door, a house with a window, a swimming pool, and the like.

The “enclosure object” obstruction object has a parameter openLevel that describes how open the opening of the enclosure is, and that parameter can take values in the range of 0 to 1, where 0 translates into an opening that is fully closed and 1 translates into an opening that is fully open. The “enclosure object” obstruction object also preferably has two effect-level parameters, openEffectLevel and closedEffectLevel, which specify the effect level for the fully-open enclosure and the fully-closed enclosure, respectively. The overall effect-level of the “enclosure object” obstruction can then be given by the following:

effectLevel = openLevel • openEffectLevel +

(1 - openLevel) • closedEffectLevel

The openEffectLevel, closedEffectLevel, and openLevel parameters can also be combined in other ways. For example, the open and closed effect levels can separately affect the slope, stop-band attenuation, pass-band attenuation, and cut-off frequency of the stop-band in the underlying filter. The opening effect level can be used to derive a combination of these filter parameter values, e.g., by linear or non-linear interpolation of the values. It will be appreciated that setting the openLevel parameter to 0 and using the closedEffectLevel parameter enable the “enclosure object” obstruction object to model the class of enclosure objects without openings.

The “enclosure object” type of obstruction can alternatively be specified in terms of a set of predefined objects, such as a chest, a closet, etc., each of which then automatically sets respective values of the openEffectLevel and closedEffectLevel parameters for the object. A data structure that can be used to specify such an obstruction object is a specification data structure ObstructionSpec_EnclosureObj_t, which can be written as follows:

typedef struct ObstructionSpec_EnclosureObj {

| | | |
|---|---|---|
| permillie | openLevel; | // 0 to 1000 |
| permillie | openEffectLevel; | // 0 to 1000 |
| permillie | closedEffectLevel; | // 0 to 1000 |

| | |
|---|---|
| ObstructionName_EnclosureObj_t | obstructionName; |

} ObstructionSpec_EnclosureObj_t;

in which the data type ObstructionName_EnclosureObj_t is an enumeration of predefined obstruction object names. Such an enumeration can be written as follows, for example:

typedef enum {

OBSTRUCTIONNAME_CHEST = 0,
OBSTRUCTIONNAME_CLOSET,
OBSTRUCTIONNAME_CARTRUNK,
OBSTRUCTIONNAME_HOUSE_WITH_DOOR,
OBSTRUCTIONNAME_HOUSE_WITH_WINDOW,
OBSTRUCTIONNAME_SWIMMINGPOOL,

} ObstructionName_EnclosureObj_t;

As an alternative, the obstructionName variable can be excluded from the data structure ObstructionSpec_EnclosureObj_t and the predefined object names can be mapped directly to values of the openEffectLevel and closedEffectLevel variables. Such mapping can be done in the C language with #define statements. For example, several such statements are as follows:

#define ENCLOSURENNAME_CHEST_OPEN 1
#define ENCLOSURENNAME_CHEST_CLOSED 802
#define ENCLOSURENNAME_HOUSE_WITH_WINDOW_OPEN 54
#define ENCLOSURENNAME_HOUSE_WITH_WINDOW_CLOSED 555

Another common type of obstruction object is the “surface object”, which can be used to represent physical surface objects that a sound wave propagates over, such as theater seats, parking lots, fields, sand surfaces, forests, sea surfaces, and the like. This type of obstruction object is conveniently parameterized in terms of the surface roughness by a roughness parameter, a relativeEffectLevel parameter that quantifies the level of the effect, and a distance parameter that quantifies the distance sound travels over the surface.

The roughness parameter can take values in the range of 0 to 1, where 0 translates into a surface that is fully smooth and 1 translates into a surface that is fully rough. The relativeEffectLevel variable is given a value of 1 when the path of the sound wave is very close to the surface and a value that decreases to zero as the path moves farther away from the surface.

A data structure that can be used to specify the “surface object” type of obstruction is a specification data structure ObstructionSpec_SurfaceObj_t, which can be written as follows:

typedef struct ObstructionSpec_SurfaceObj {

| | | |
|---|---|---|
| permillie | roughness; | // 0 to 1000 |
| permillie | relativeEffectLevel; | // 0 to 1000 |

| | |
|---|---|
| centimeter | distance; |

ObstructionName_SurfaceObj_t obstructionName;

} ObstructionSpec_SurfaceObj_t;

in which the data type ObstructionName_SurfaceObj_t is an enumeration of predefined obstruction object names. Such an enumeration can be written as follows, for example:

typedef enum {

OBSTRUCTIONNAME_THEATER_SEATS = 0,
OBSTRUCTIONNAME_PARKING_LOT,
OBSTRUCTIONNAME_FIELD,
OBSTRUCTIONNAME_SAND,
OBSTRUCTIONNAME_FOREST,
OBSTRUCTIONNAME_SEA,
OBSTRUCTIONNAME_CUSTOM

} ObstructionName_SurfaceObj_t;

The roughness and relativeEffectLevel variables can be combined to separately affect the slope, stop-band attenuation, pass-band attenuation, and cut-off frequency of the stop-band in the underlying filter. Likewise, the distance variable can affect the slope, stop-band attenuation, pass-band attenuation, and cut-off frequency of the stop-band in the underlying filter. In a manner similar to the “enclosure object” type, the presets may alternatively be defined by the use of #define statements or their equivalents.

A fourth type of obstruction object is the “medium object”, which is used to represent a physical propagation medium, such as air, fog, snow, rain, stone pillars, forest, water, and the like. The “medium object” type of object is conveniently parameterized in terms of the density of the medium (quantified by a density variable) and the distance traveled by sound through the medium (quantified by a distance variable). A data structure that can be used to specify this type of obstruction object is the specification data structure ObstructionSpec_MediumObj_t, which can be written as follows:

typedef struct ObstructionSpec_MediumObj {

| | | |
|---|---|---|
| permillie | density; | // 0 to 1000 |
| centimeter | distance; | |

ObstructionName_MediumObj_t obstructionName;

} ObstructionSpec_MediumObj_t;

in which the data type ObstructionName_MediumObj_t is an enumeration of predefined obstruction object names. Such an enumeration can be written as follows, for example:

typedef enum {

OBSTRUCTIONNAME_AIR = 0,
OBSTRUCTIONNAME_FOG,
OBSTRUCTIONNAME_SNOW,
OBSTRUCTIONNAME_RAIN,
OBSTRUCTIONNAME_STONE_PILLARS,
OBSTRUCTIONNAME_FOREST,
OBSTRUCTIONNAME_WATER,
OBSTRUCTIONNAME_CUSTOM

} ObstructionName_MediumObj_t;

The density and distance variables can be combined to separately affect the slope, stop-band attenuation, pass-band attenuation, and cut-off frequency of the stop-band in the underlying filter. In a manner similar to the “enclosure object” type, the presets may alternatively be defined by the use of #define statements or their equivalents.

Another type of obstruction object is the “custom object”. For a “custom object”, the obstruction specification is preferably given directly in terms of a filter specification.

In the above described five different types of obstruction objects, effect level parameters are used to dimension the underlying obstruction (low-pass or high-pass) filters. It should be understood that it is also possible to specify the filter parameters directly instead and to use the parameters relativeEffectLevel and openLevel to interpolate between those filter parameters.

The following is an example of how an obstruction object, such as a blocking object and a surface object, is used to dimension a filter as illustrated by FIGS. 3-7. The specification parameters for a blocking obstruction object are the maxEffectLevel and relativeEffectLevel, which are preferably mapped to the effectLevel parameter through the following equation:

effectLevel=relativeEffectLevel·maxEffectLevel.

The effectLevel parameter is then mapped to the above-described filter characteristics gain, cut-off frequency, and stop band attenuation through respective functional relationships gain(effectLevel), freq(effectLevel), and atten(effectLevel). The filter characteristics are then mapped to a set of implementable filter parameters as described above.

For example, the mapping functions can be constructed as follows. The function gain(effectLevel) preferably has a value 0 dB for effectLevel=0 and a value “minimum filter gain” for effectLevel=1. The minimum filter gain is typically around −20 dB, although other values could be used. Between those two extremes, the gain mapping function should be a monotonically decreasing function, e.g., a line or other monotonically decreasing continuous curve. The function freq(effectLevel) preferably has a value 0 for effectLevel=1 and a value “maximum bandwidth” for effectLevel=0, which may be 0.5 times the sampling rate (i.e., the Nyquist rate) of a digital-to-analog converter used by the audio device. Between those two extremes, the cut-off frequency mapping function should also be a monotonically decreasing function. The function atten(effectLevel) preferably has a value −10 dB for effectLevel=0 and a value “maximum stop-band attenuation” for effectLevel=1, where the maximum stop-band attenuation depends on the maximum filter order supported by the implementation. A typical maximum stop-band attenuation is −30 dB. Between the two extremes, the stop-band mapping function should be a monotonically decreasing step function that takes values that are integer multiples of −10 dB.

FIG. 8 is a flow chart that illustrates a method of simulating obstruction or occlusion of sound by an object by obstruction objects as described above. In step 802, at least one environmental parameter is specified for an obstruction object that corresponds to the simulated obstructive/occlusive object. In step 804, the environmental parameters are transformed to a set of filter characteristics. As described above, the filter characteristics may include a filter type, a cut-off frequency, and a stop-band attenuation, although it will be understood that any technique for representing an obstruction by a filter can be used. In step 806, the set of filter characteristics is transformed into a set of filter parameters, and that set can be used by a filtering operation that is performed on an input sound signal. The set of electronic filter characteristics can be transformed by mapping the filter characteristics to a set of filter parameters that define an IIR or FIR filter.

As an example of how these object types and parameters can be used for a VR application, consider an environment in which a listener is walking outside a house on the listener's right. The house's wall to the right of the listener includes a slightly open, single-pane window and a closed, heavy door, and loud music is playing in the house. In a simulated 3D audio environment, the window and the door would be modeled as two separate 3D audio sources that share a common audio source signal but have separate obstruction objects. The window would preferably be simulated by an enclosure object of the type OBSTRUCTIONNAME_HOUSE_WITH_WINDOW and the door by an enclosure object of the type OBSTRUCTIONNAME_HOUSE_WITH_DOOR. As the window is slightly open, the openLevel parameter for the window obstruction object may be set to 0.2, and as the door is closed, the openLevel parameter for the door obstruction object may be set to 0. It can be noted that the perceived thickness of door can be altered by changing the closedEffectLevel parameter, e.g., a lower value simulates a thinner door. As the listener walks by the house, the listener first hears the sound from the open window and the door in front of him/her, then to the side as the listener passes them, and then from behind after the listener has passed them. The corresponding changes in the simulated sound are taken care of by the 3D audio engine using head-related (HR) filters, interaural time differences (ITDs), distance attenuation, and directional gain, while the muffling effect of the sound coming from the house is handled by the obstruction filtering described in this application. It will be understood that the particular values described can be changed without departing from this invention.

### Control/Signal Flow

A system implementing a VR audio environment typically supports many simultaneous 3D audio sources that are combined to generate one room sound signal feed and one direct sound signal feed. The room sound signal feed is generally directed to a reverberation-effects generator, and the direct sound signal feed is generally directed to a direct-term mix generator or final mix generator.

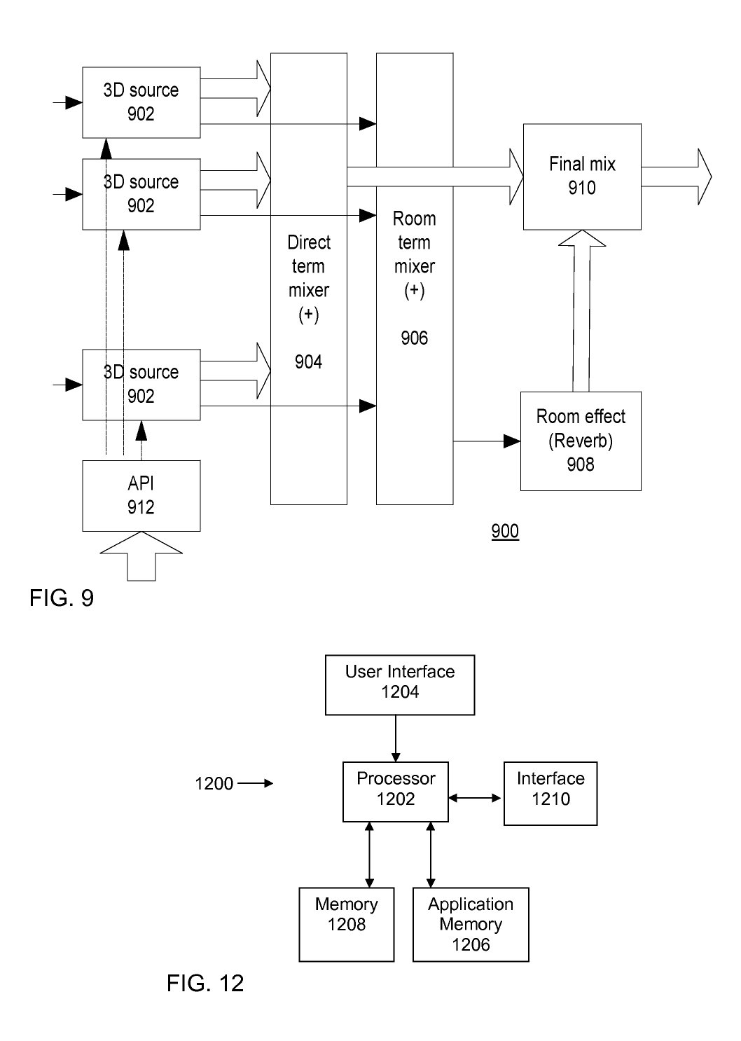

FIG. 9 is a functional block diagram of a sound renderer 900, showing several sound signals entering respective 3D source blocks 902 from the left-hand side of the figure. The entering sound signals can come from files that are read from memory, that are streamed over a network, and/or that are generated by a synthesizer (such as a MIDI synthesizer), etc. The entering sound signals may also be processed/transcoded, e.g., decoded or filtered, before entering. It will be appreciated that the renderer 900 can be realized by a suitably programmed electronic processor or other suitably configured electronic circuit.

Each 3D source block 902 processes the entering sound signal and generates a direct-term signal, which represents a perceptually positioned, processed version of the entering sound signal, and a room-term signal. The direct-term signals are provided to a direct-term mixer 904, which generates a combined direct-term signal from the input signals. The room-term signals are provided to a room-term mixer 906, which generates a combined room-term signal from the input signals. The combined room-term signal is provided to a room-effect process 908, which modifies the combined room-term signal and generates a combined room-effect signal having desired reverberation effects. The combined direct-term signal and combined room-effect signal are provided to a final mixer 910, which produces the sound signal of the sound renderer 900. A VR application controls the behavior of the rendered 500 (in particular, the parameters of the filter functions implemented by the blocks 502) using an API 912.

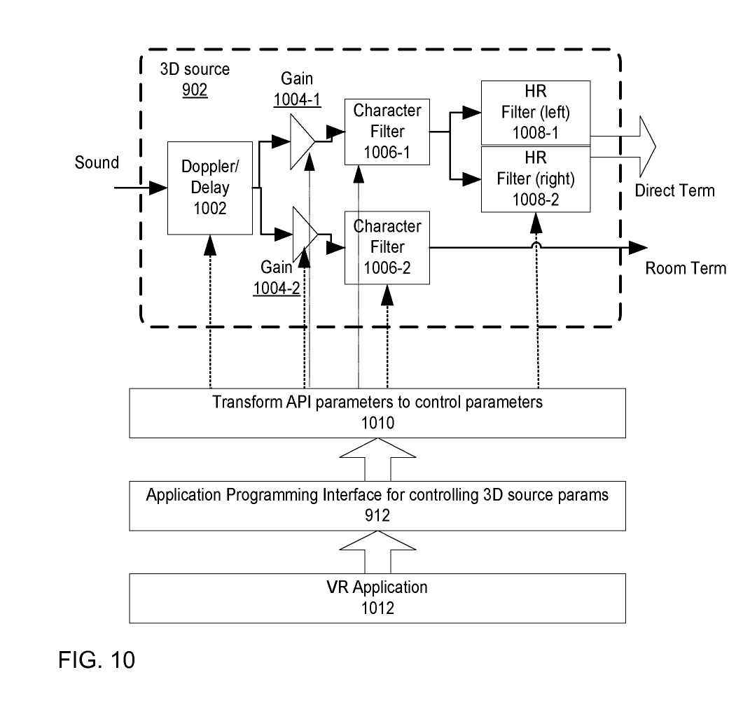

FIG. 10 is a block diagram of a 3D source block 902, showing the links between the API 912 and the filter parameters. As seen in FIG. 10, the sound signal entering on the left-hand side can be selectively delayed and Doppler-shifted (frequency-shifted) by a Doppler/delay block 1002 and selectively level-shifted (amplitude-shifted). Two gain blocks (amplifiers) 1004-1, 1004-2 are advantageously provided for the direct-term signal and room-term signal, respectively. Two character filters 1006-1, 1006-2 are respectively provided for the direct-term and room-term signals. Each filter 1006 is a low-pass or high-pass filter that alters the spectral character of its input signal, which corresponds to a colorization or equalization of the sound signal and can be used to simulate acoustic obstruction and occlusion phenomena.

The output of the character filter 1006-1 in the direct-term path is provided to a pair of HR filters 1008-1, 1008-2, which carry out spatial positioning and externalization of the direct sound signal. Methods and apparatus of externalization are described in U.S. patent application Ser. No. 11/744,111 filed on May 3, 2007, by P. Sandgren et al. for “Early Reflection Method for Enhanced Externalization”, which is incorporated here by reference.

It will be understood that the Doppler/delay block 1002, gain blocks 1004, character filters 1006, and HR filters 1008 can be arranged in many different ways and can be combined instead of being implemented separately as shown. For example, the gains 1004 can be included in the character filters 1006, and the gain 1004-1 can be included in the HR filters 1008. The character filter 1006-1 can be included in the HR filter 1008-1. The Doppler/delay block 1002 can be moved and/or divided so that the delay portion is just before the HR filtering. Also, the Doppler shifting can be applied separately to the direct-term and room-term feeds.

Each character filter 1006 can be specified, at a low level, by a filter type, cut-off frequency, and stop-band strength, and those filter specification parameters are mapped, or transformed, to a set of parameters that specify an actual filter implementation, e.g., a signal processing operation, as described above. As depicted in FIG. 10, the mapping is advantageously performed by a software interface or API 1010 between a VR application's API 912 and the actual filter implementation in the source 902. The VR application 1012 changes the filter specification parameters when it updates the objects in the VR audio environment. The updates reflect changes in obstruction and occlusion derived from other objects as well as the source and the listener objects.

### Mapping Occlusion/Obstruction to Filter Parameters

As described above, the VR audio application 1012 includes software objects with descriptions of obstructing and occluding phenomena, source's and listener's geometries, and so on. The interface 1010 transforms that information into the filter parameters, e.g., cut-off frequency and filter type.

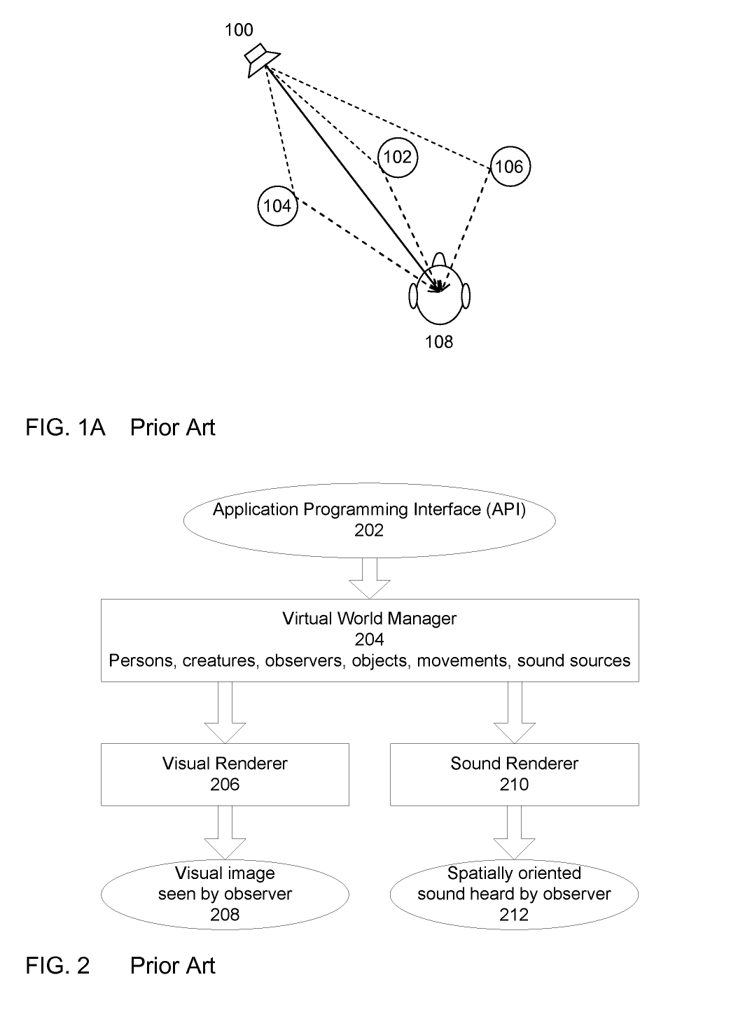

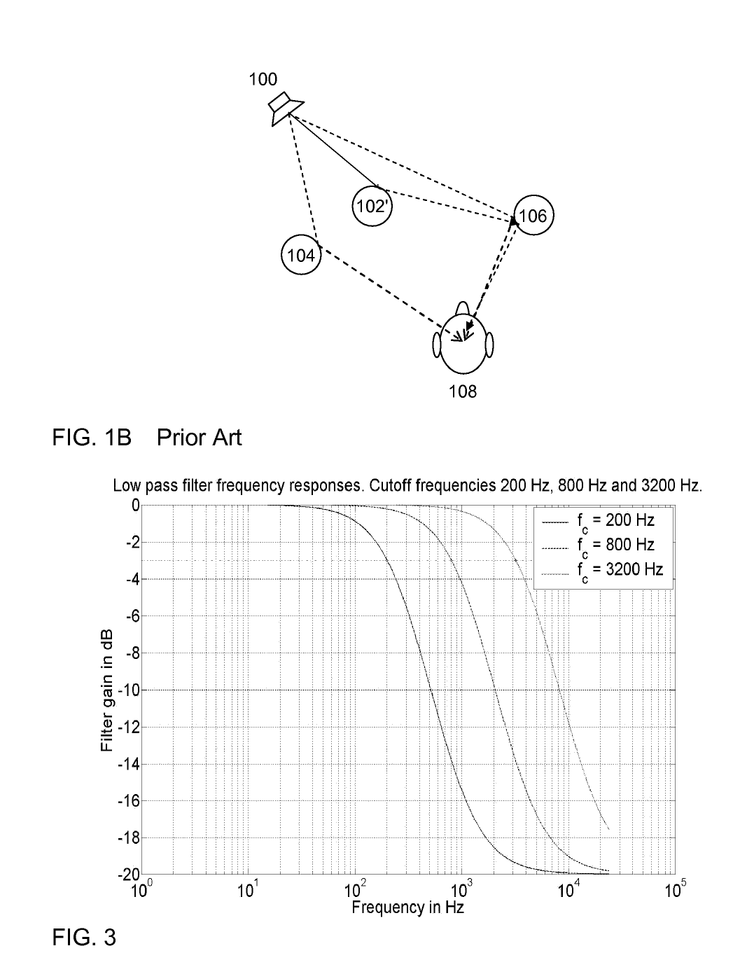

FIG. 1B is a typical example of occlusion, in which the direct-term signal from the source 100 to the listener 108 is low-pass filtered due to the effect of the object 102′. The room-term signal from the source 100 might also be affected but in a lesser degree due to its paths in the simulated environment being less obstructed. Thus, for such an example, the VR application developer could choose to use the low-pass filter type and the weak stop-band strength for the characteristics of the room-term character filter 1006-2 and to use the low-pass filter type and nominal stop-band strength for the direct-term character filter 1006-1.

The cut-off frequencies of the character filters 1006 are selected based on how large the object 102′ is in order to simulate obstructing the sound. For example, if the source 100 is near to the object 102′ and in the middle of the object 102′ (with respect to the listener 108), the filter cut-off frequency is a low frequency. As the source 100 moves away from the object 102′ or toward an edge of the object 102′, the cut-off frequency is increased, widening the filter pass-band and hence making the sound less affected by the low-pass filter. Also, the gain of the direct term can be lowered to simulate that the object 102′ hinders sound at all frequencies although high-frequency sounds are more obstructed.

For another example, consider a listener 108 in one room and a sound source 100 in another room, with a closed door (i.e., an object 102′) between the rooms. The filter type can be low-pass with nominal stop-band strength for both the direct-term and room-term character filters 1006-1, 1006-2. The gains 1004-1, 1004-2 can both be low because both the direct-term and room-term feeds are highly obstructed. The cut-off frequency of the direct-term character filter 1006-1 can be at a low frequency to simulate the muffled sound typical of a sound coming from another room. The cut-off frequency of the room-term character filter 1006-2 can also be at a low frequency. If the door is opened (i.e., the object 102′ is removed or modified), the gain 1004-1 of the direct term is increased to simulate more sound passing through the open door. Also, the cut-off frequency of the direct-term character filter 1006-1 is increased because the sound should seem less muffled. The gain 1004-2 and cut-off frequency of the room-term character filter 1006-2 can be less affected by the door's being opened, but they can also increase somewhat.

The foregoing describes ways for a VR application to map its geometric/acoustic object descriptions to the filter specification parameters cut-off frequency and filter type. It will be understood that these are only examples and that a VR application can use any filter specification parameters that are available to affect the sound in any way it sees fit. The filter specification parameters can even be used for controlling the sound for purposes other than simulating occlusion and obstruction.

### API Based on Filter Parameter Specification

As just one of many possible examples, an API configured to control the character filters 1006 and gains 1004 in a sound source 902 includes a structure containing the two filter specification parameters filter type and cut-off frequency as follows:

typedef struct filterParameters {

| | |
|---|---|
| millieHertz | cutOffFrequency; |
| filterType | filterType; |

} filterParameters_t;

The filterParameters structure describes the parameters of a filter 1006 that affects the sound that is fed to the direct-term mixer 904 or the room-term mixer 906. The filter 1006 can be either a low-pass or a high-pass filter, which is set by the filterType parameter. The cutoffFrequency parameter describes the frequency that splits the spectrum into the pass band (the frequency band where the sound passes) and the stop band (the frequency band where the sound is attenuated). Finally, the strength of the filter is also specified by the filterType parameter. A stronger filter type accentuates the sound level difference between the stop band and the pass band.

In this example, the cutoffFrequency parameter is specified in milli-Hz, i.e., 0.001 Hz, where the valid range is [0, UINT_MAX]. UINT_MAX is the maximum value an unsigned integer can take. If a cutoffFrequency parameter value is larger than half the current sampling frequency (e.g., 48 KHz), then the API should limit the cutoffFrequency value to half the sampling frequency. This is advantageous in that the cutoffFrequency can be set independent from the current sampling rate, although the renderer actually behaves in accordance with the Nyquist limit.

The filterType parameter can for example be one of those specified in an enumerated type description, such as the following:

typedef enum {

FILTERTYPE_LOW_PASS_WEAK = 0,
FILTERTYPE_LOW_PASS_NOMINAL,
FILTERTYPE_LOW_PASS_STRONG,
FILTERTYPE_HIGH_PASS_WEAK = 32,
FILTERTYPE_HIGH_PASS_NOMINAL,
FILTERTYPE_HIGH_PASS_STRONG

} filterType;

Of course it will be understood that other filter types can be specified.

As examples, a gain 1004 and the parameters of a character filter 1006 can be controlled by the following methods.

The following is an exemplary method of setting the level that is used as one of the inputs to derive the gain on the room-term sound signal in FIG. 10:

ResultCode SetRoomLevel(

3DSourceObject *3DSource,
millibel level
);

The 3DsourceObject variable specifies which of several possible 3D sources is affected. The ResultCode variable can be used to return error/success codes to the VR application.

The following is an exemplary method of getting the level that is used as one of the inputs to derive the gain on the room-term sound signal in FIG. 10:

ResultCode GetRoomLevel(

3DSourceObject *3DSource,
millibel *pLevel
);

The following is an exemplary method of setting the filter specification parameters described above that are used as inputs to derive the filter implementation parameters on the room-term sound signal in FIG. 10:

ResultCode SetRoomCharacter(

3DSourceObject *3DSource,
filterParameters_t filtParam
);

The following is an exemplary method of getting the filter specification parameters described above that are used as inputs to derive the filter implementation parameters on the room-term sound signal in FIG. 10:

ResultCode GetRoomCharacter(

3DSourceObject *3DSource,
filterParameters_t *pFiltParam
);

The following is an exemplary method of setting the level that is used as one of the inputs to derive the gain on the direct-term sound signal in FIG. 10:

ResultCode SetDirectLevel(

3DSourceObject *3DSource,

millibel level

);

The following is an exemplary method of getting the level that is used as one of the inputs to derive the gain on the direct-term sound signal in FIG. 10:

ResultCode GetDirectLevel(

3DSourceObject *3DSource,

millibel *pLevel

);

The following is an exemplary method of setting the filter specification parameters described above that are used as inputs to derive the filter implementation parameters on the direct-term sound signal in FIG. 10:

ResultCode SetDirectCharacter(

3DSourceObject *3DSource,

filterParameters_t filtParam

);

The following is an exemplary method of getting the filter specification parameters described above that are used as inputs to derive the filter implementation parameters on the direct-term sound signal in FIG. 10:

ResultCode GetDirectCharacter(

3DSourceObject *3DSource,
filterParameters_t *pFiltParam

);

### API Based on Obstruction/Occlusion Parameter Specification

The data structures and types defined above are used in methods of determining the gains 1004 and parameters of the character filters 1006.

The following is an exemplary method of setting the room level that is used as an added reduction or increase of the level besides the obstruction/occlusion parameter settings:

ResultCode SetRoomLevel(

3DSourceObject *3DSource,
millibel level
);

The 3DsourceObject variable specifies which of the 3D sources that is affected, and the ResultCode variable can be used to return error/success codes to the VR application.

The following is an exemplary method of getting the room level that is used as an added reduction or increase of the level besides the obstruction/occlusion parameter settings:

ResultCode GetRoomLevel(

3DSourceObject *3DSource,
millibel *pLevel
);

The following is an exemplary method of setting the obstruction and occlusion specification parameters described above that are used as inputs to derive the filter implementation parameters on the room-term and direct-term sound signals in FIG. 10:

ResultCode SetObstruction(

3DSourceObject *3DSource,
Obstruction_t *obstruction
);

The following is a method of getting the obstruction and occlusion specification parameters described above that are used as inputs to derive the filter implementation parameters on the room-term and direct-term sound signals in FIG. 10:

ResultCode GetObstruction (

3DSourceObject *3DSource,
Obstruction_t *obstruction
);

The following is an exemplary method of setting the direct-term level that is used as an added reduction or increase of the level besides the obstruction/occlusion parameter settings:

ResultCode SetDirectLevel(

3DSourceObject *3DSource,
millibel level
);

The following is an exemplary method of getting the direct-term level that is used as an added reduction or increase of the level besides the obstruction/occlusion parameter settings:

ResultCode GetDirectLevel(

3DSourceObject *3DSource,
millibel *pLevel
);

It should be understood that all of the exemplary methods described above can be implemented separately or in combination as desired and suitable, which is to say that a VR application can have some objects defined by “low level” filter specifications and other objects defined by “high level” object type specifications. The exemplary methods also can be implemented on other filter specification interfaces, or via other means. For example, a “high level” object type specification as described above may be based on a “low level” filter specification as described above or on other suitable “low level” filter specifications, such as those described in the Background section of this application.

FIG. 11 is a flow chart that illustrates a method of generating a signal, which may be an electronic signal, that corresponds to simulated obstruction or occlusion of sound by at least one simulated obstructive/occlusive object. The method includes a step 1102 of selecting filtering characteristics that represent the obstructive/occlusive object. As described above, the selection can involve choosing a cut-off frequency and a stop-band attenuation, or choosing an object type and at least one value of at least one variable that quantifies an obstructive/occlusive effect of the selected object type. The method also includes a step 1104 of selectively amplifying an input sound signal based on the selected filtering characteristics, and a step 1106 of selectively filtering the input sound signal based on the selected filtering characteristics. As a result, the signal is generated.

FIG. 12 is a block diagram of an equipment 1200 for simulating obstruction or occlusion of sound by an object. It will be appreciated that the arrangement depicted in FIG. 12 is just one example of many possible devices that can include the devices and implement the methods described in this application. The equipment 1200 includes a programmable electronic processor 1202, which may include one or more sub-processors, and which executes one or more software applications and modules to carry out the methods and implement the devices described in this application. Information input to the equipment 1200 is typically provided through a keypad, a microphone for receiving sound signals, and/or other such device, and information output by the equipment 1200 is typically provided to a suitable display and speakers or earphones for producing sound signals. Those devices are parts of a user interface 1204 of the UE 1200. Software applications may be stored in a suitable application memory 1206, and the equipment may also download and/or cache desired information in a suitable memory 1208. The equipment 1200 may also include a suitable interface 1210 that can be used to connect other components, such as a computer, keyboard, etc., to the equipment 1200.

The equipment 1200 can receive sets of filter characteristics and transform those sets into sets of filter parameters as described above. For example, the equipment 1200 can map a set of electronic filter characteristics into a set of filter parameters that define IIR or FIR filters. Suitably programmed, the equipment 1200 can also implement the set of filter parameters as a digital filter. The equipment 1200 can also generate a signal that corresponds to simulated obstruction or occlusion of sound by a simulated obstructive/occlusive object by selectively filtering an input sound signal based on the digital filter. As noted above, sound signals can be provided to the equipment 1200 through the interfaces 1204, 1210 and filtered as described above. It should be understood that the methods and devices described above can be included in a wide variety of equipment having suitable programmable or otherwise configurable electronic processors, e.g., personal computers, media players, mobile communication devices, etc.

This application describes methods and systems for simulating virtual audio environments having obstructions and occlusions using filter specification parameters cut-off frequency and filter type for direct-sound and room-effect signals. These parameters are well known for filter specifiers and hence are easy to use for application developers having some knowledge of acoustics. This gives such developers flexibility and control over the spectral character of the obstructed/occluded sound and the dynamic changes of that spectral character. The sound characteristics will be flexible and detailed enough to allow the occlusion/obstruction effect to be rendered in a way that is perceived as realistic. It will also eliminate unnecessary detail and the associated additional computational complexity that does not significantly add to the perceived realness of the simulated effect.

This application also describes methods and systems for simulating virtual audio environments having obstructions and occlusions using a more conceptual approach that is more appropriate for developers who are not so familiar with acoustic filtering effects. Environmental terminology is used to describe acoustic effects in terms of the type of obstruction/occlusion (e.g., wall, wall with opening, etc.), which has the benefit of faster application development. Technical benefits can include greater freedom in the implementation, which can be used to obtain a high-quality or low-cost implementation.

It is expected that this invention can be implemented in a wide variety of environments, including for example mobile communication devices. It will be appreciated that procedures described above are carried out repetitively as necessary. To facilitate understanding, many aspects of the invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both. Many communication devices can easily carry out the computations and determinations described here with their programmable processors and associated memories and application-specific integrated circuits.

Moreover, the invention described here can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a RAM, a ROM, an erasable programmable read-only memory (EPROM or Flash memory), and an optical fiber.

Thus, the invention may be embodied in many different forms, not all of which are described above, and all such forms are contemplated to be within the scope of the invention. For each of the various aspects of the invention, any such form may be referred to as “logic configured to” perform a described action, or alternatively as “logic that” performs a described action.

It is emphasized that the terms “comprises” and “comprising”, when used in this application, specify the presence of stated features, integers, steps, or components and do not preclude the presence or addition of one or more other features, integers, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

What is claimed is:

1. A method of simulating obstruction or occlusion of sound by at least one simulated obstructive/occlusive object, comprising the step of:
transforming a set of electronic filter characteristics into a set of filter parameters for a filter for altering a sound signal based on the filter characteristics, wherein the set of electronic filter characteristics represents the obstructive/occlusive object and includes at least a filter type, a cut-off frequency, and a stop-band attenuation.

2. The method of claim 1, wherein the filter type is selected from a high-pass type and a low-pass type, and the stop-band attenuation is selected from three levels of stop-band attenuation.

3. The method of claim 1, wherein transforming the set of electronic filter characteristics comprises mapping the set of filter characteristics to a set of filter parameters that define at least one of an infinite-impulse-response filter and a finite-impulse-response filter, and the method further comprises the step of performing a filtering operation according to the set of filter parameters.

4. The method of claim 1, further comprising the steps of:
implementing a digital filter in terms of the set of filter parameters; and
generating a signal that corresponds to simulated obstruction or occlusion of sound by the at least one simulated obstructive/occlusive object by selectively filtering an input sound signal based on the digital filter.

5. An apparatus for simulating obstruction or occlusion of sound by at least one simulated obstructive/occlusive object, comprising:
a programmable processor configured to transform a set of electronic filter characteristics into a set of filter parameters for a filter for altering a sound signal based on the electronic filter characteristics, wherein the set of electronic filter characteristics represents the obstructive/occlusive object and includes at least a filter type, a cut-off frequency, and a stop-band attenuation.

6. The apparatus of claim 5, wherein the filter type is one of a high-pass type and a low-pass type, and the stop-band attenuation is one of three levels of stop-band attenuation.

7. The apparatus of claim 5, wherein the processor transforms the selected electronic filter characteristics by:
mapping selected filter characteristics to a set of filter parameters that define one of an infinite-impulse-response filter and a finite-impulse-response filter; and
implementing a digital filter in terms of the set of filter parameters.

8. The apparatus of claim 5, wherein the processor generates a signal that corresponds to simulated obstruction or occlusion of sound by the at least one simulated obstructive/occlusive object by selectively filtering an input sound signal based on the filter.

9. A method of simulating obstruction or occlusion of sound by at least one simulated obstructive/occlusive object, comprising the steps of:
transforming at least one environmental parameter for at least one of a plurality of obstruction objects that corresponds to the at least one simulated obstructive/occlusive object into a set of electronic filter characteristics; and
transforming the set of electronic filter characteristics into a set of filter parameters for a filter for altering an input sound signal based on the identified electronic filter characteristics.

10. The method of claim 9, wherein the plurality of obstruction objects includes at least one of the following:
a blocking object that represents a physical object and that is parameterized by at least a maximum effect level parameter and a relative effect level parameter;
an enclosure object that represents a physical object having an interior space and that is parameterized by at least an open level parameter, an open effect level parameter, and a closed effect level parameter;
a surface object that represents a physical surface and that is parameterized by at least a surface roughness parameter, a relative effect level parameter, and a distance parameter; and
a medium object that represents a sound propagation medium and is parameterized by at least a density parameter and a distance parameter.

11. The method of claim 10, wherein the environmental parameters of at least one obstruction object are specified for a respective set of predetermined physical objects.

12. The method of claim 9, wherein the set of electronic filter characteristics includes at least a filter type, a cut-off frequency, and a stop-band attenuation.

13. The method of claim 12, wherein the filter type is selected from a high-pass type and a low-pass type, and the stop-band attenuation is selected from three levels of stop-band attenuation.

14. The method of claim 9, wherein transforming the set of electronic filter characteristics comprises:
mapping the set of electronic filter characteristics to a set of filter parameters that defines one of an infinite-impulse-response filter and a finite-impulse-response filter; and
implementing a digital filter in terms of the set of filter parameters.

15. The method of claim 9, further comprising the steps of:
implementing a digital filter in terms of the set of filter parameters; and
generating a signal that corresponds to simulated obstruction or occlusion of sound by the at least one simulated obstructive/occlusive object by selectively filtering an input sound signal based on the filter.

16. An apparatus for simulating obstruction or occlusion of sound by at least one simulated obstructive/occlusive object, comprising:
a programmable processor configured to transform at least one environmental parameter for at least one of a plurality of obstruction objects that corresponds to the at least one simulated obstructive/occlusive object into a set of electronic filter characteristics, and to transform the set of electronic filter characteristics into a set of filter parameters for a filter for altering an input sound signal based on the identified electronic filter characteristics.

17. The apparatus of claim 16, wherein the plurality of obstruction objects include at least one of the following:
a blocking object that represents a physical object and that is parameterized by at least a maximum effect level parameter and a relative effect level parameter;
an enclosure object that represents a physical object having an interior space and that is parameterized by at least an open level parameter, an open effect level parameter, and a closed effect level parameter;
a surface object that represents a physical surface and that is parameterized by at least a surface roughness parameter, a relative effect level parameter, and a distance parameter; and
a medium object that represents a sound propagation medium and is parameterized by at least a density parameter and a distance parameter.

18. The apparatus of claim 17, wherein a respective set of predetermined physical objects specifies the parameters of at least one obstruction object.

19. The apparatus of claim 16, wherein the identified filter characteristics include a filter type, a cut-off frequency, and a stop-band attenuation.

20. The apparatus of claim 19, wherein the filter type is one of a high-pass type and a low-pass type, and the stop-band attenuation is one of three levels of stop-band attenuation.

21. The apparatus of claim 16, wherein the processor transforms the set of electronic filter characteristics by:
mapping the set of filter characteristics to a set of filter parameters that define one of an infinite-impulse-response filter and a finite-impulse-response filter; and
the processor is further configured to implement a digital filter in terms of the set of filter parameters.

22. The apparatus of claim 16, wherein the processor is further configured to implement a digital filter in terms of the set of filter parameters and to generate a signal that corresponds to simulated obstruction or occlusion of sound by the at least one simulated obstructive/occlusive object by selectively filtering an input sound signal based on the digital filter.
